(19) United States
(12) Patent Application Publication
(10) Pub. No.: US 2025/0162502 A1
(43) Pub. Date: May 22, 2025

(54) METHOD AND SYSTEM FOR DETECTING FEATURES OF A VEHICLE TRAILER

(71) Applicant: Continental Autonomous Mobility Germany GmbH, Ingolstadt (DE)

(72) Inventor: Ulrich Schaub, Ulm (DE)

(73) Assignee: Continental Autonomous Mobility Germany GmbH, Ingolstadt (DE)

(21) Appl. No.: 18/953,465

(22) Filed: Nov. 20, 2024

(30) Foreign Application Priority Data
Nov. 20, 2023 (DE) 10 2023 211 494.1

(51) Int. Cl. B60R 1/00; B60R 1/25; B60R 1/26

(52) U.S. Cl. CPC B60R 1/003; B60R 1/25; B60R 1/26; B60Y 2200/147; B60Y 2400/3015

(57) ABSTRACT

A method and system are disclosed for capturing parameters of a trailer by means of sensor technology of the towing vehicle while the vehicle/trailer combination is driving.

### CROSS-REFERENCE TO RELATED APPLICATIONS

The present application claims the benefit and/or priority of German Patent Application 10 2023 211 494.1 filed on Nov. 20, 2023, the content of which is incorporated by reference herein.

### TECHNICAL FIELD

The invention relates to a method and a system for detecting parameters of a vehicle trailer.

### BACKGROUND

It is known that vehicles, in particular passenger cars and trucks, have various assistance systems and sensors for monitoring an environmental region behind the vehicle. Due to their safety relevance, the assistance systems are subject to various legal regulations and standards.

In order to electronically monitor the rear region of the vehicle, traditional rearview mirrors of the vehicle are replaced or supplemented by cameras. Examples of these are reversing camera systems and mirror replacement systems.

Trailer assistance systems in different forms are also known. These offer, for example, a maneuvering aid during reversing, a warning if there is too significant a difference between the alignment of the vehicle longitudinal axis with respect to the trailer longitudinal axis (so-called jackknife warning) or a virtual, at least partially transparent representation of the towed trailer on a monitor.

To date, for such functions of trailer assistance systems, it has been necessary to enter geometric data of the trailer manually in order to be able to ensure the correct functionality of the trailer assistance system based on the data. This is time-consuming and requires measuring equipment along with technical understanding. This is undesirable and, in addition, inconvenient due to time constraints, especially in the case of an identical trailer which is not utilized regularly, for example in the case of rental trailers, or in the case of frequent changes in professional operation.

In addition, erroneous data entries in current trailer assistance systems cannot be investigated or can only be investigated very coarsely for inconclusiveness. As a result, erroneous data entries frequently remain unidentified and can lead to safety-critical maneuvers.

### SUMMARY

Proceeding herefrom, it is an object indicate a method for detecting features of a vehicle trailer, which renders time-consuming manual and error-prone entry of data regarding a vehicle trailer unnecessary and makes possible automatic and convenient online data capturing during trailer operation of the vehicle.

The object is achieved by a method having the features of the independent claim 1. Example embodiments are the subject-matter of the subclaims. A system is the subject-matter of the alternative, independent claim 15.

According to a first aspect, a method is disclosed for capturing parameters of a trailer by means of sensor technology of the towing vehicle. The parameters can include geometric parameters, the trailer alignment and also other trailer properties (type of trailer, type of axle, etc.). The towing vehicle and the trailer form a vehicle/trailer combination with at least one hinge point. The method includes the following steps:

Initially, features of the trailer drawbar are captured by means of a reversing camera of the towing vehicle while the towing vehicle is driving straight ahead. The fact that the towing vehicle is driving straight ahead can be established via the steering angle provided by the steering angle sensor, wherein it should be noted that the trailer follows the course of the towing vehicle driving straight ahead with a delay and/or a transient oscillation. The features of the trailer drawbar can either be points, lines or other visual features of the trailer drawbar, by means of which the alignment of the trailer drawbar can be captured when the towing vehicle is driving straight ahead. The trailer drawbar features are subsequently stored as the reference state in order to have these available in future for the calculation of the trailer alignment with respect to the towing vehicle.

During driving and based on the stored trailer drawbar features, the articulation angle of the vehicle/trailer combination is subsequently calculated. In addition to the articulation angle, further information can additionally be calculated, which specifies the orientation of the trailer in space. The articulation angle is the angle between the longitudinal axis of the towing vehicle and the longitudinal axis of the trailer. The calculation of the articulation angle may be carried out iteratively so that the current articulation angle is continually available while the vehicle/trailer combination is driving.

Furthermore, at least one part of the front face of the trailer facing the towing vehicle as well as the distance thereof from the hinge point of the vehicle/trailer combination are captured. This can, for example, be carried out by means of the sensor technology present on the towing vehicle, in particular the reversing camera of the towing vehicle.

When the vehicle/trailer combination is driving around a bend, the steering angle of the towing vehicle and the articulation angle of the vehicle/trailer combination are captured. Based on the information, the distance between the kinematically effective trailer axle and the hinge point of the vehicle/trailer combination is calculated.

Finally, further trailer features are captured by means of image information, wherein the image information is provided by at least one side camera of the towing vehicle, which acquires the rear region to the side of the towing vehicle.

The technical advantage of the proposed method is that, based on the sensor technology of the towing vehicle, an automatic, sequential capturing of trailer parameters is carried out online, i.e., during driving. As a result, a manual, error-prone and inconvenient capturing of the trailer parameters is dispensed with. This is especially advantageous when different trailers are frequently utilized, for example, in the commercial environment or in the case of rented trailers.

According to one exemplary embodiment, the drawbar position of the trailer is determined based on the captured features of the trailer drawbar when the towing vehicle is driving straight ahead. In this case, “drawbar position” is in particular understood to be the position and alignment of the trailer drawbar as a whole or at least of partial regions of the trailer drawbar. The captured drawbar position when the vehicle is driving straight ahead is considered to be the reference, inter alia, for the establishment of the articulation angle of the vehicle/trailer combination.

According to one exemplary embodiment, the articulation angle of the vehicle/trailer combination is determined while the vehicle/trailer combination is driving from a comparison of the drawbar position when driving straight ahead and the current drawbar position captured by means of the reversing camera. As a result, the articulation angle of the vehicle/trailer combination can be automatically calculated by means of the image information of the reversing camera of the towing vehicle.

According to one exemplary embodiment, the width of the trailer construction is determined based on the image information of the reversing camera. Therefore, following coupling of the trailer, the width of the same can be established easily.

According to one exemplary embodiment, the total width of the trailer is determined based on the image information of the reversing camera and/or the image information of at least one backward-oriented side camera of the towing vehicle, which capture(s) the rear region to the side of the towing vehicle (for example, designed as a “mirror replacement camera”). The total width of the trailer can differ, due to laterally overhanging trailer regions, for example, the tires or a lighting unit, from the width of the trailer construction itself. Based on the image information of the reversing camera and/or at least one side camera, it can be determined whether such lateral overhangs exist. The total width of the trailer can be deduced from the width of the trailer construction and the dimensions of the lateral overhangs.

According to one exemplary embodiment, the height of the trailer is determined based on the image information of the reversing camera and/or the image information of at least one side camera of the towing vehicle, which capture(s) the rear region to the side of the towing vehicle. The height of the trailer can vary along the longitudinal axis of the trailer. For example, this can increase or decrease toward the rear. In order to correctly reproduce the height of the trailer, the information of the reversing camera and the side cameras can either be individually processed or fused so that the height of the image of the trailer corresponds to the actual height of the trailer.

According to one exemplary embodiment, the length of the trailer is determined based on the image information of at least one side camera of the towing vehicle, which capture(s) the rear region to the side of the towing vehicle. During cornering of the vehicle/trailer combination, the side camera of the towing vehicle can capture the side region of the trailer in a perspective view. The length of the trailer can be determined from the perspective view.

According to one exemplary embodiment, the type of axle of the trailer (e.g., individual axle, double axle, etc.) is established based on the image information of at least one side camera of the towing vehicle, which capture(s) the rear region to the side of the towing vehicle. During cornering of the vehicle/trailer combination, the side camera of the towing vehicle can capture the side region of the trailer in a perspective view and therefore the at least one axle of the trailer as well. The type of axle of the trailer can therefore be automatically established.

According to one exemplary embodiment, a virtual, partly transparent image of the trailer is generated based on the captured trailer features. The virtual image of the trailer forms a model of the trailer with its existing geometrical size ratios in reality and other equipment, for example, the type of the construction, the type of axle, etc. The image can be displayed on a monitor of the towing vehicle so that a realistic image of the trailer is displayed to the driver of the towing vehicle. Due to the transparency of the model, the driver can see through the trailer and capture the environmental region behind the trailer despite the representation of the trailer.

Additionally, these virtual geometries of the trailer overlaid on the image have the safety-relevant function of permanently reminding the driver of the real dimensions of the trailer despite the virtual transparency, and therefore minimizing the risk of these being psychologically disregarded.

According to one exemplary embodiment, an environmental representation of the rear region, which is located behind the towing vehicle, is created by a driving assistance system of the towing vehicle. The virtual, partly transparent image of the trailer is integrated into the environmental representation. As a result, a realistic representation of the vehicle environment also including the trailer is achieved.

According to one exemplary embodiment, the environmental representation of the rear region of the towing vehicle is produced from image information which is provided by cameras of the towing vehicle, and image information which is provided by a camera, in particular by a rear camera of the trailer. Thanks to the overlaying of the image information, regions which are concealed from the cameras of the towing vehicle by the trailer can also be captured and included in the environmental model of the vehicle.

According to one exemplary embodiment, the captured trailer features are transmitted to a driving assistance system or an autonomous driving system of the towing vehicle. The driving decisions of the driving assistance system or of the autonomous driving system are made based on the trailer features. Therefore, the driving assistance system or the autonomous driving system can utilize the information of the trailer in order to make driving decisions based thereon, for example, whether the gap between two vehicles is sufficient in order to execute a lane change.

According to a further aspect, a system is disclosed for capturing parameters of a trailer which can be moved by a towing vehicle. The towing vehicle and the trailer form a vehicle/trailer combination with at least one hinge point. The system includes a reversing camera assigned to the towing vehicle and at least one pair of backward-oriented side cameras assigned to the towing vehicle, which capture the rear region to the side of the towing vehicle, and a computing unit. The computing unit is configured to execute the following steps of:
Capturing features of the trailer drawbar by means of the reversing camera of the towing vehicle while the towing vehicle is driving straight ahead, and storing the trailer drawbar features;
During driving and based on the stored trailer drawbar features, calculating the articulation angle of the vehicle/trailer combination as the angle between the longitudinal axis of the towing vehicle and the longitudinal axis of the trailer;
Capturing at least one part of the front face of the trailer facing the towing vehicle as well as the distance thereof from the hinge point of the vehicle/trailer combination;
During cornering, capturing the steering angle of the towing vehicle and the articulation angle of the vehicle/trailer combination;
Calculating the distance between the effective trailer axle and the hinge point of the vehicle/trailer combination based on the steering angle of the towing vehicle and the articulation angle of the vehicle/trailer combination; and
Capturing further trailer features by means of image information of at least one side camera of the towing vehicle.

Within the meaning of the present disclosure, the expressions “approximately,” “substantially” or “roughly” mean deviations from the exact value in each case by +/−10%, preferably by +/−5%, and/or deviations in the form of changes which are insignificant to the function.

Further developments, advantages and possible applications of the present disclosure are also set out by the following description of exemplary embodiments and by the figures. All of the features described and/or pictured per se or in any combination are in principle the subject-matter of the present disclosure, irrespective of their combination in the claims or references back thereto. The content of the claims is also made an integral part of the description.

### BRIEF DESCRIPTION OF THE DRAWINGS

The present disclosure is explained in greater detail below on the basis of figures with reference to exemplary embodiments, wherein:

FIG. 1 shows, by way of example, a schematic top view representation of a vehicle/trailer combination including a towing vehicle and a trailer;

FIG. 2 shows, by way of example and schematically, an image of the trailer in a front view; and

FIG. 3 shows, by way of example, a block diagram, which illustrates the steps of a method for online capturing of parameters of a trailer.

### DETAILED DESCRIPTION

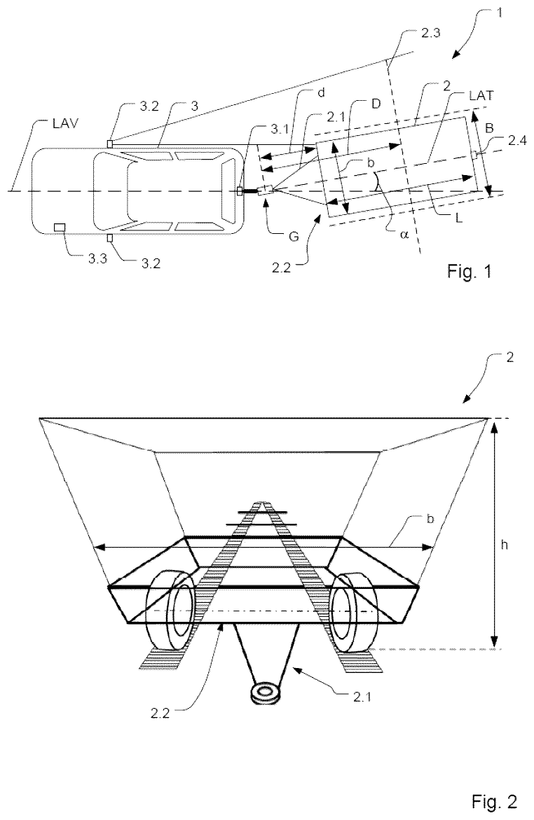

FIG. 1 shows, by way of example and schematically, a vehicle/trailer combination made up of a towing vehicle 3 and a trailer 2, wherein a system 1 for capturing parameters of the trailer 2 is provided on the towing vehicle 3.

The system includes a reversing camera 3.1 and at least two side cameras 3.2, by means of which the lateral region behind the towing vehicle 3 can be captured. In addition, the system 1 also includes a computer unit 3.3 which is configured, based on the sensor technology of the towing vehicle 3, to capture geometrical parameters of the trailer 2, in particular the image information provided by the reversing camera 3.1 and provided by the side cameras 3.2.

The towing vehicle 3 includes, on the rear of the vehicle, a trailer coupling is positioned to which the free end of a trailer drawbar 2.1 of the trailer 2 can be connected. The trailer coupling is in particular a trailer ball to which a hitch of the trailer 2 can be coupled.

The trailer drawbar 2.1 may be rigidly connected to the frame of the trailer 2. The trailer 2 can, for example, be designed as a single-axle trailer or include a tandem axle. In an alternative embodiment, the trailer can, however, also include two axles, wherein the front axle is connected in the manner of a rotational joint to the frame of the trailer 2 as a steering axle, and can be swiveled about a vertical axis of the trailer 2 by the trailer drawbar 2.1.

The steps to capture the trailer features are described in greater detail below based on the representation in FIG. 2.

FIG. 2 shows, by way of example, a virtual image of a trailer 2 as it can be represented, for example, on a monitor of the towing vehicle 3.

In order to produce such a virtual image of the trailer 2, parameters of the trailer 2 must be captured while the vehicle/trailer combination is driving. This is carried out gradually in temporally consecutive steps as described, for example, in greater detail below.

In order to capture the parameters of the trailer 2, a capturing routine is run through after the trailer has been coupled. The start of the capturing routine is in particular initiated in that a coupled trailer 2 has been captured by the towing vehicle 3. Alternatively, the start of the capturing routine can also be initiated manually, for example, by a start command entered at a user interface, in particular a menu.

As already indicated above, the towing vehicle 3 has a reversing camera 3.1, the capturing region of which is aligned to the rear region of the towing vehicle 3. Features of the trailer drawbar 2.1 are captured by means of the reversing camera 3.1 while the towing vehicle 3 is driving straight ahead. The alignment of the trailer drawbar 2.1 when driving straight ahead is considered to be the reference in order to be able to determine the articulation angle α of the vehicle/trailer combination based thereon, which articulation angle describes the acute angle opening toward the side facing away from the towing vehicle 3 between the longitudinal axis LAV of the towing vehicle and the longitudinal axis LAT of the trailer 2 as represented in FIG. 1. The point in time when the vehicle/trailer combination is driving straight ahead is determined, based on information of the steering angle sensor of the towing vehicle 3. The vehicle/trailer combination is in particular driving straight ahead when the steering angle of the towing vehicle is 0° or substantially 0° at least over a predefined period of time. If available, at least partial information can also be provided by means of a camera which determines information regarding the replacement of the interior mirror.

The trailer drawbar features captured when driving straight ahead are stored. Based on the stored trailer drawbar features, the articulation angle α of the vehicle/trailer combination can be determined during cornering of the vehicle/trailer combination and, indeed, for example, by a comparison of the stored trailer drawbar features with the image information of the trailer drawbar 2.1 acquired by the reversing camera 3.1 during the cornering of the vehicle/trailer combination. The articulation angle α can be calculated by applying geometrical relationships from the captured trailer drawbar features and the saved trailer drawbar features.

In addition, information regarding the front face 2.2 of the trailer 2 can be captured by the sensor technology of the towing vehicle 3, in particular by means of the reversing camera 3.1 thereof and may include, for example, the width b of the trailer construction and also the height h of the trailer 2 in the region of the front face.

Likewise, the distance of the front face 2.2 of the trailer 2 from the reversing camera 3.1 can be established. If the horizontally measured distance between the trailer coupling of the towing vehicle 3 and the reversing camera 3.1 is known, the distance d of the front face 2.2 of the trailer 2 from the coupling point of the trailer coupling and therefore from the hinge point G of the vehicle/trailer combination can be determined from the distance.

During cornering of the towing vehicle 3, the distance D of the effective trailer axle 2.3 from the hinge point G can, in addition, be calculated. In the case of a trailer 2 having an individual axle, the effective trailer axle 2.3 is the individual axle itself. In the case of a trailer 2 having a tandem axle, the effective trailer axle 2.3 is a virtual axle which runs centrally and parallel between the two individual axles of the tandem axle. The distance D can be calculated, during cornering of the vehicle/trailer combination, from the ratio of the steering angle of the towing vehicle and the resulting articulation angle α of the vehicle/trailer combination during driving. This can be carried out, for example, via a linear single-track model of the vehicle/trailer combination made up of the towing vehicle 3 and the trailer 2. Alternatively, other kinematic models can also be used for calculating the distance D.

In addition, during cornering of the vehicle/trailer combination, image information of the side regions of the trailer 2 can be captured with the side cameras 3.2 of the towing vehicle 3. In FIG. 1, the capturing region of the right side camera 3.2 of the towing vehicle 3 is sketched, by way of example. The capturing region extends over the rear region to the side, so that when driving around a right-hand bend, the right side region of the trailer 2 lies in the capturing region of the right side camera 3.2. It is understood that, when driving around a left-hand bend, the left side region of the trailer 2 can be captured by means of the left side camera 3.2.

By evaluating the image information which is provided by the at least one camera, further trailer features can be captured. These are, for example:
Length L of the trailer;
Type of axle (e.g., individual axle, tandem axle, etc.)
Side overhangs which increase the total width of the trailer (low-bed trailer or high-bed trailer, laterally overhanging lights, etc.);
Type and profile of the trailer construction, in particular height profile of the trailer;
Wheel diameter
In the case of a tandem axle, the axle distance of the two individual axles.

A virtual image of the trailer 2 can be generated from the parameters of the trailer determined consecutively in time either gradually or in a single step, wherein the virtual image replicates the trailer 2 in its size (e.g., length, width and height) and other properties (type of axle, construction, etc.). The virtual image can be displayed, for example, in conjunction with a surround-view system on a monitor of the towing vehicle 3, and/or utilized by a driving assistance system of the vehicle in order to make driving decisions (e.g., is a lane change possible on the basis of the length of the vehicle/trailer combination?).

A virtual image of the trailer 2 can be produced from the determined trailer features, which is represented, for example, depending on the driving situation, on a monitor of the towing vehicle 3. As a result, the trailer 2 can be represented in terms of size and alignment in the towing vehicle 3 as this is actually the case in reality.

If the trailer 2 itself has at least one camera, in particular a rear camera 2.4, by means of which the environment behind the trailer 2 can be captured, the information provided by the at least one camera, in particular the rear camera 2.4, can also be used for creating the virtual image of the trailer 2. In particular, an environmental representation can be produced from the image information provided by the cameras of the towing vehicle 3 and the image information provided by the at least one camera of the trailer 2, into which environmental representation the image of the trailer 2 is at least partially integrated in a partly transparent manner. In other words, the rear environment of the towing vehicle 3, in which the trailer 2 is indeed contained, can be represented in the towing vehicle 3, but the region behind the trailer is also visible through the trailer. The advantage of this is that the driver of the towing vehicle 3 is constantly reminded that a trailer 2 is also being towed, however the trailer does not completely prevent the view backward, but rather the environment behind the trailer also remains visible due to the part transparency thereof, which significantly increases the driving safety.

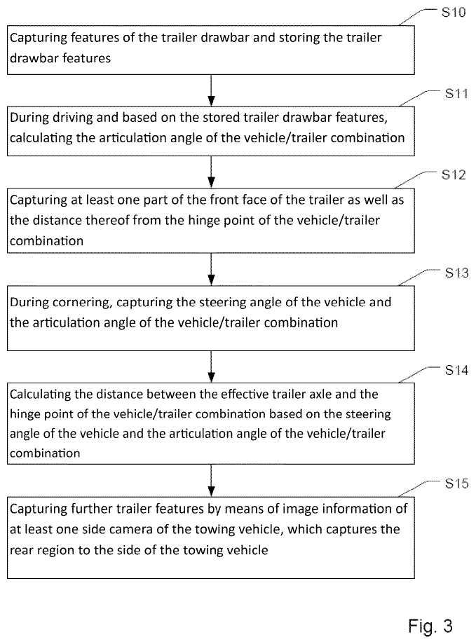

FIG. 3 shows a schematic block diagram which illustrates the method steps for capturing parameters of a trailer. The method steps can be processed in the sequence indicated below or, alternatively, in a sequence deviating therefrom.

Initially, features of the trailer drawbar are captured by means of a reversing camera of the towing vehicle while the towing vehicle is driving straight ahead. The captured trailer drawbar features are subsequently stored (S10).

Subsequently, during driving and based on the stored trailer drawbar features, the articulation angle of the vehicle/trailer combination is calculated as the angle between the longitudinal axis of the towing vehicle and the longitudinal axis of the trailer (S11).

Furthermore, at least one part of the front face of the trailer facing the towing vehicle as well as the distance thereof from the hinge point of the vehicle/trailer combination are captured (S12).

When the vehicle/trailer combination made up of the towing vehicle and trailer is driving around a bend, the steering angle of the towing vehicle and the articulation angle of the vehicle/trailer combination are captured (S13).

Based on the steering angle of the towing vehicle and the articulation angle of the vehicle/trailer combination, the distance between the effective trailer axle and the hinge point of the vehicle/trailer combination is calculated (S14).

In addition, further trailer features are captured by means of image information of at least one side camera of the towing vehicle, which captures the rear region to the side of the towing vehicle (S15).

The present disclosure has been described above using exemplary embodiments. It goes without saying that numerous changes as well as modifications are possible without leaving the scope of protection defined by the claims.

### LIST OF REFERENCE NUMERALS

1 System
2 Trailer
2.1 Trailer drawbar
2.2 Front face
2.3 Effective trailer axle
2.4 Rear camera
3 Towing vehicle
3.1 Reversing camera
3.2 Side camera
3.3 Computer unit
b Width
B Total width
d Distance
D Effective axle distance
G Hinge point
h Height
LAT Longitudinal axis of the trailer
LAV Longitudinal axis of the towing vehicle

1) A method for capturing parameters of a trailer by at least one sensor of the towing vehicle, wherein the towing vehicle and the trailer form a vehicle/trailer combination with at least one hinge point, wherein the method comprises:
capturing features of a trailer drawbar of the trailer by reversing camera of the towing vehicle while the towing vehicle is driving straight ahead, and storing the trailer drawbar features;
during driving and based on the stored trailer drawbar features, calculating an articulation angle of the vehicle/trailer combination as the angle between the longitudinal axis of the towing vehicle and the longitudinal axis of the trailer;
capturing at least one part of a front face of the trailer facing the towing vehicle as well as a distance thereof from the hinge point of the vehicle/trailer combination;
during cornering, capturing a steering angle of the towing vehicle and the articulation angle (a) of the vehicle/trailer combination;
calculating a distance between an effective trailer axle and the hinge point of the vehicle/trailer combination based on the steering angle of the towing vehicle and the articulation angle of the vehicle/trailer combination; and
capturing further trailer features by image information of at least one side camera of the towing vehicle, which captures a rear region to a side of the towing vehicle.

2) The method according to claim 1, wherein drawbar position of the trailer is determined based on the captured features of the trailer drawbar when the towing vehicle is driving straight ahead.

3) The method according to claim 2, wherein the articulation angle of the vehicle/trailer combination is determined while the vehicle/trailer combination is driving from a comparison of the drawbar position when driving straight ahead and the current drawbar position captured by the reversing camera.

4) The method according to claim 1, wherein a width of the trailer construction is determined based on the image information of the reversing camera.

5) The method according to claim 4, wherein a total width of the trailer is determined based on the image information of the reversing camera and/or the image information of the at least one side camera of the towing vehicle, which captures the rear region to the side of the towing vehicle.

6) The method according to claim 1, a height of the trailer is determined based on at least one of the image information of the reversing camera or the image information of the at least one side camera of the towing vehicle, which capture(s) the rear region to the side of the towing vehicle.

7) The method according to claim 1, wherein a length of the trailer is determined based on the image information of the at least one side camera of the towing vehicle, which capture(s) the rear region to the side of the towing vehicle.

8) The method according to claim 1, wherein an effective trailer axle is a single axle or a virtual central axle between individual axles of a tandem axle of the trailer.

9) The method according to claim 1, wherein a type of axle of the trailer is established based on the image information of the at least one side camera of the towing vehicle, which capture(s) the rear region to the side of the towing vehicle.

10) The method according to claim 1, wherein a virtual, partly transparent image of the trailer is generated based on the captured trailer features.

11) The method according to claim 10, wherein the virtual, partly transparent image of the trailer is represented at least occasionally on a monitor of the towing vehicle.

12) The method according to claim 10, wherein an environmental representation of the rear region, which is located behind the towing vehicle, is created by a driving assistance system of the towing vehicle, and the virtual, partly transparent image of the trailer is integrated into the environmental representation.

13) The method according to claim 12, wherein the environmental representation of the rear region of the towing vehicle is produced from image information which is provided by the reversing camera and the at least one side camera of the towing vehicle, and the image information which is provided by a camera of the trailer.

14) The method according to claim 1, wherein the captured trailer features are transmitted to a driving assistance system or an autonomous driving system of the towing vehicle, and driving decisions of the driving assistance system or of the autonomous driving system are made based on the trailer features.

15) A system for capturing parameters of a trailer which is moved by a towing vehicle, wherein the towing vehicle and the trailer form a vehicle/trailer combination with at least one hinge point, wherein the system comprises a reversing camera assigned to the towing vehicle and at least one pair of side cameras assigned to the towing vehicle, which capture a rear region to a side of the towing vehicle, and a computer unit, wherein the computer unit is configured to execute the following:
capturing features of the trailer drawbar by the reversing camera of the towing vehicle while the towing vehicle is driving straight ahead, and storing the trailer drawbar features;
during driving and based on the stored trailer drawbar features, calculating the articulation angle of the vehicle/trailer combination as the angle between the longitudinal axis of the towing vehicle and the longitudinal axis of the trailer;
capturing at least one part of a front face of the trailer facing the towing vehicle as well as a distance thereof from the at least one hinge point of the vehicle/trailer combination;
curing cornering, capturing a steering angle of the towing vehicle and the articulation angle of the vehicle/trailer combination;
calculating a distance between an effective trailer axle and the at least one hinge point of the vehicle/trailer combination based on a steering angle of the towing vehicle and the articulation angle of the vehicle/trailer combination; and
capturing further trailer features by image information of at least one side camera of the towing vehicle.
